(19) United States
(12) Patent Application Publication
(10) Pub. No.: US 2009/0253454 A1
(43) Pub. Date: Oct. 8, 2009

(54) AUTOMATIC CHANGING MODE OF A COMMUNICATION DEVICE

(76) Inventor: Scott E. Sampson, Orem, UT (US)

Correspondence Address: STOEL RIVES LLP - SLC, 201 SOUTH MAIN STREET, SUITE 1100, ONE UTAH CENTER, SALT LAKE CITY, UT, 84111, US

(21) Appl. No.: 12/061,521

(22) Filed: Apr. 2, 2008

(51) Int. Cl. H04M 1/00

(52) U.S. Cl. 455/550.1

(57) ABSTRACT

A communication device records a current mode, which is an indication of how incoming communications and other alert events are to be processed. We provide a mode stack, which records modes that have been the current mode, with means for determining which one or more mode stack entries constitutes the current mode. We also provide for an automode table, which records events that will trigger specific modes to be automatically registered and unregistered on the mode stack. Automode table entries may be based on temporal events such as from electronic calendars, based on geographical events such as determined by GPS or RFID, based on application events such as phone or media player usage, based on communication events such as establishing a communication link with a Bluetooth device, or based on other detectable events. The result is a device that can automatically adjust mode and alert response according to predefined conditions.

### TECHNICAL FIELD

The present disclosure relates generally to communication systems. More specifically, the present disclosure relates to systems and methods for automatically determining the mode of communication devices so that such devices can automatically adjust the way they handle various functions and alert events such as receiving incoming communications.

Copyright Notice

©2008 Scott E. Sampson. A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR §1.71(d).

### BRIEF DESCRIPTION OF THE DRAWINGS

FIG. 1 is a schematic diagram of a system for automatically changing the mode of a communication device.

FIG. 2 illustrates exemplary configurations of automode tables.

FIG. 3 illustrates hypothetical automode table entries.

FIG. 4 is a flowchart of a method for automode configuration.

FIG. 5 is a flowchart of a method for updating a mode.

FIG. 6 is a flowchart of a method for processing an incoming communication.

FIG. 7 is a schematic diagram of automode functionality within a general user-alert system.

FIG. 8 illustrates exemplary configurations of a mode stack.

FIG. 9 illustrates an exemplary mode stack as it changes throughout a hypothetical day.

FIG. 10 shows exemplary device actions that are contingent upon the current device mode.

FIG. 11 is a simplified high-level block diagram of a communication device in one embodiment of this invention.

### DETAILED DESCRIPTION

The telephone has been a great invention. However, a drawback of having a telephone is the interruption of receiving incoming phone calls at inappropriate times. For example, it can be very inconvenient and annoying to have the phone ring when a person is asleep or sitting down to dinner.

The introduction of mobile phones has made things worse. People have mobile phones with them in a lot of different places and during a lot of different activities. For example, it can be embarrassing for a mobile phone to ring during a theater performance. Likewise, it can be dangerous for a mobile phone to ring while a person is driving a vehicle.

A previous way such problems have been partially addressed is through a mobile phone “manner mode” or “meeting mode.” When a phone is in that type of mode, it may vibrate to signal incoming calls instead of producing an audible alert. One problem with that approach is if the person forgets to change his or her phone to manner mode at the start of a musical performance, the phone will ring. Another problem occurs when the person forgets to take the phone out of manner mode after the performance, and then misses some incoming calls because the phone does not give audible signals.

Other functions of mobile devices also produce signals that might need to be controlled besides incoming communications. For example, a mobile device may reference a calendar that stores events of interest to a device operator, and some of the events may have alert settings. Often, such calendar events may trigger audible alerts, which again may be appropriate at some times and places but inappropriate at other times and places.

Of course, a mobile device such as a PDA (personal digital assistant) may have a calendar that is locally stored, with the need to control event alerts through device modes even if the device is not connected to some communication network. Nevertheless, controlling alerts on devices that are connected to communications networks is of particular concern, since they have more potential alerts, such as motivated by incoming communications.

Also, it is also possible to have a communication device that is not mobile provide alerts that need situational control. For example, it might be annoying for a home telephone to ring while people are having dinner. The present disclosure relates to controlling alerts and functions of non-mobile communication devices. Nevertheless, mobile communication devices are of particular interest because they experience a greater variety of circumstances in which it might be desirable for alerts and functions to be controlled.

The use of communication device modes is not limited to voice communication. For example, text-messaging systems such as “instant messaging” and email clients may alert operators at the arrival of incoming messages, which can be problematic if the alerts occur at inappropriate times and at inappropriate places. It is common for such systems to allow operators to set a system status of “away” or “not available” which tells other communicators (i.e., people who might send messages) that the operator is not available to communicate at that time, which status is a type of device mode. There are limitations to those prior systems. First, the system status generally takes effect for all other communicators without regard for the type of other communicators or the communication purposes of the other communicators. Second, the system status generally needs to be manually set by the system operator, which can be a hassle or forgotten. Third, the system status generally can only be set to one current value at a given time, with no hierarchy of current setting values. These limitations can be overcome as described hereafter.

There is utility in ability for communication devices that provide alerts to have modes that cause alert events to be handled as appropriate. As mentioned earlier, many mobile phones have a “manner mode” or “meeting mode” which suppresses audible alerts for incoming calls. Besides forgetting to change modes at appropriate times, another problem with those phones is that the mode set is limited and predefined and not user extensible. The present disclosure allows for more flexibility in modes by allowing more modes. However, if a greater variety of modes are considered, the manual changing of modes can be even more burdensome. One benefit of the present disclosure is simplifying and automating the management of various device modes.

The present disclosure provides significant utility by allowing a multiplicity of user-extensible device modes, and providing the means for the device to automatically change current modes without the need for user intervention. The user can specify events and conditions that are to automatically trigger a change in the current device mode, and subsequently the device can act on those specified events in order to control the mode of the device. We refer to this as an “automode.”

The concept of automodes was introduced in co-pending application 11/368,583 (“Controlling incoming communication by issuing tokens”). Therein, it was described that the recipient might indicate his or her current status through the user interface of the communication device by setting the ‘mode’ of the communication device, and alternatively the recipient status might be assumed according to a predefined mode schedule. The example was given that the recipient's communication system might assume a mode of ‘unavailable’ during normal sleeping hours and ‘available’ otherwise. This present disclosure expands upon the prior application by describing automode functionality in more detail. In particular, the concept of a “predefined mode schedule” is herein described to potentially include registered events that might be time events, location events, communication events, and various other types of events. One can specify a mode schedule in an “automode table,” which indicates how the device mode is to automatically change according to the occurrence of the specified events.

One example of an automode is specifying that the device is to enter a specific mode when the device enters a specified geographic location. A device may be able to detect its current geographic location through GPS (global positioning system), proximity to a wireless transmission device, sensing of a nearby RFID (radio frequency identification) device, or other means. For example, a device operator may use that location detection functionality to record the geographic location of his/her workplace and then indicate in an automode table that whenever the device enters that recorded geographic location, the device should automatically assume a device mode that indicates that the operator is at his/her workplace. Subsequent alerts and functions on the device can then be controlled according to that device mode, such as giving priority to incoming calls from coworkers.

In this example, the device operator may eventually leave the work location, and return home. The device can be configured to detect that the operator has left the work location and/or entered the home location, and the device mode can automatically change to indicate the operator is no longer at work but at home. If the operator prefers to not receive work-related calls at home, the device can be configured to divert work-related calls directly to a voicemail system to record messages from such callers. A method and system for managing such control was disclosed in the inventor's prior patents, U.S. Pat. No. 7,010,565 (“Communication management using a token action log”) and U.S. Pat. No. 7,233,961 (“Managing a message communication and file system”), as well as published patent application Ser. No. 11/368,583 (“Controlling incoming communication by issuing tokens,” publication number 20060168089), which are incorporated herein by reference. This disclosure expands upon automatic control of device modes.

In one embodiment, a communication device has a set of device modes. Preferably, the set of device modes is user extensible. Also, in one embodiment, the communication device has a stored value or values that indicate the current device mode. In one embodiment the communication device has a stored list of registered device mode values with one mode value on the list being the current device mode value. For example, the most recently registered device mode value on the list might be considered the current device mode value. Modes can be “registered” by being marked as current, by being added to the list, or by other means. The present disclosure refers to the list of registered device mode values a “mode stack.”

In one embodiment, the device is configured so that specific events trigger changes in the current device mode. These mode-changing events can be of various types, including but not limited to entering a geographical area, communicating with an external device, receiving an incoming communication, reaching a specified day and time, or executing a particular device function or operation. It is useful that the device is able to automatically detect the mode-changing events so that the mode can automatically change without the need for subsequent user intervention. The following are some descriptions of potential automode functionality.

Geographic location events. Sometimes it is desirable to modify the device mode according to the geographic location of the device. In the example mentioned previously, the device might have an “at work” mode that should be assumed when the device operator is at work. In one embodiment, the work location might be specified by geographic coordinates and an indication of the size of the workspace. When the device detects that it has entered the specified space, such as through a Global Positioning System or other means, it can automatically change into “at work” mode. When the device detects that it has left the specified space it can automatically change out of “at work” mode into some other registered device mode, such as the next most recently registered device mode value in a mode stack.

Proximal events. Related to geographical events are proximal events, in which the device comes into spatial proximity to some other entity. For example, a device user may put a Radio Frequency Identification (RFID) tag in his or her car, and configure the communication device to automatically change to “in car” mode whenever the RFID tag is detected by the device. Alternatively, a device user may put an RFID tag on his/her person, and configure a communication device at his/her work desk to automatically change to “at work” or “available” mode when the RFID tag is detected. Again, when the RFID tag is no longer detected, the communication device may revert to a previous device mode from the mode stack.

Communication events. Automode functionality may also occur when the communication device experiences communication with some other device. For example a personal computer may be equipped with a Bluetooth wireless transceiver. When the communication device detects communication with that personal computer, it may automatically change to “at computer” mode. Alternatively, a library may have a wireless network, and a patron's communication device might be configured to change to “silent” mode when the device detects the library's wireless network. When the library's wireless network is no longer detected, the device might revert to a previous device mode from the mode stack.

Temporal events. There are various types of potential automode functionality pertaining to time. The communication device might be configured to automatically change to “asleep” mode every day at a specified user bedtime. The communication device might detect calendar events from an electronic calendar, and automatically change to a specified mode for specific events at the event time. For example, the device might detect any scheduled calendar events for meetings, and automatically change to “meeting” mode at the scheduled meeting start time and change out of “meeting” mode at the scheduled meeting end time (again, perhaps reverting to the next most recently registered mode value from the mode stack).

Software events. Other automode functionality may pertain to software running on the communication device or on other devices. For example, the communication device may contain software for playing videos, and the user may configure the device to automatically change to “watching movie” mode whenever the device is playing a video. An effect of this might be that only important incoming communication (e.g. phone calls) will ring the device when it is in “watching movie” mode. When the move is over, the device might be configured to return to a previous device mode from the mode stack.

These are some examples of possible automode events, and others might exist in other embodiments. Also, this disclosure also refers to alerts for incoming phone calls as one type of alert to be controlled, with other alerts and functions being controlled in other embodiments. The focus of this disclosure is automode functionality in general, which provides systems and methods for device modes to automatically change according to predefined conditions.

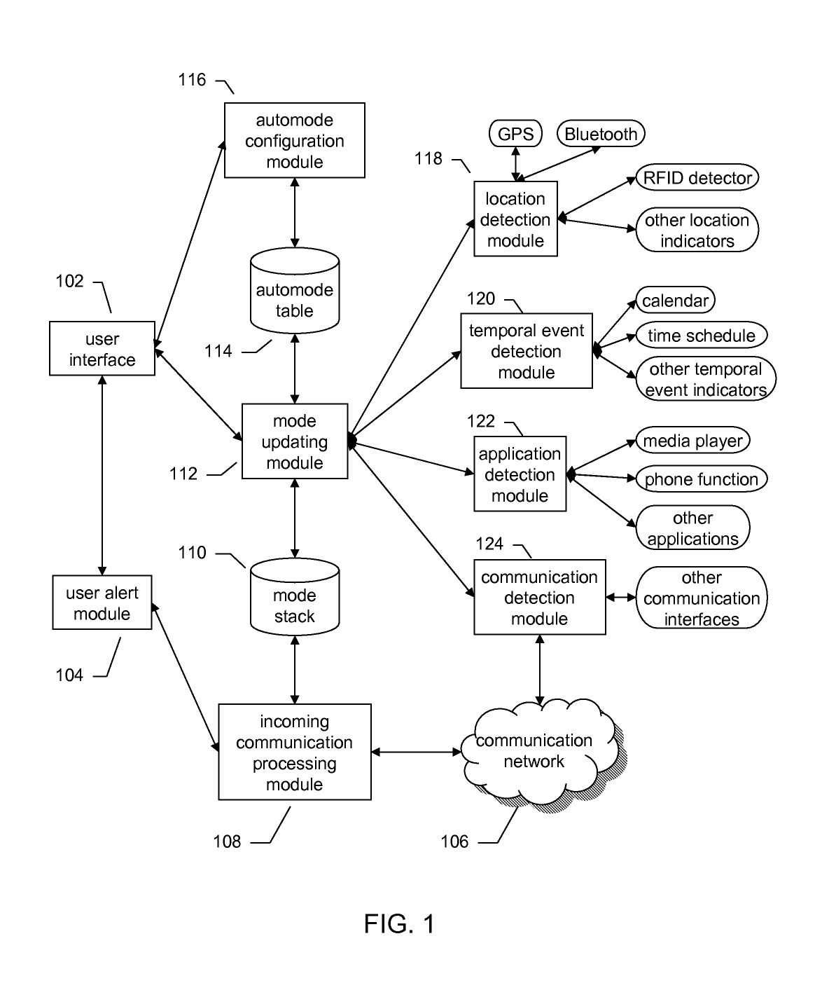

FIG. 1 shows a schematic diagram of a system for automatically changing the mode of a communication device. The system has a user interface 102 to allow a user to interact with and control the system. On occasion, the user may receive alerts from the system to signal events such as incoming communication, calendar event, and so forth. These alerts may be managed by a user alert module 104, and the alerts may be some combination of audible alerts, visual alerts, tactile alerts (such as vibration), and so forth.

The device of FIG. 1 is assumed to have access to a communication network 106. A module is provided for processing incoming communications 108, whether they be voice communications, text communications, video communications, or some other type of communications. When an incoming communication is detected 108, it is often desirable to alert the device user 104.

The way in which device users are alerted may depend on the current mode of the device. FIG. 1 has the current mode recorded in a mode stack 110, which mode stack includes one or more mode values, with one or more of the mode values being the current mode of the device. The purpose of the automode functionality is to automatically update the mode stack 110 so that the current mode represents the desires of a device user. The automatic updating of the mode stack is the purpose of the mode updating module 112.

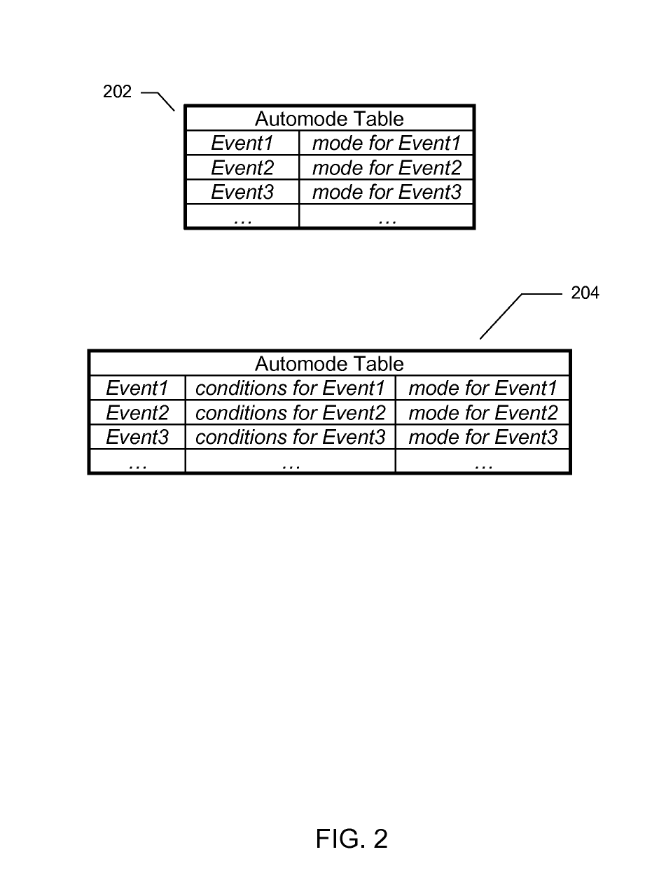

A device user can specify mode desires by configuring them in an automode table 114, which configuring is facilitated by an automode configuration module 116. Examples of automode tables are given in FIG. 2. Note that although FIG. 1 only shows one automode table 114, in other embodiments multiple automode tables may exist within a given system. The mode updating module 112 uses information in an automode table 114 (or in multiple automode tables) to determine events and/or conditions under which the mode stack 110 should be updated.

In one embodiment, an automode table 114 contains indication that the mode stack 110 should be updated based on the geographical location of the device, and a location detection module 118 is provided for that purpose. In various embodiments the location detection module 118 identifies the current location of the device through a Global Positioning System (GPS), through proximal access to other communication devices such as Bluetooth devices, through detection of a nearby Radio Frequency Identification (RFID) tag, or through other location indicators. The location detection module 118 provides relevant device location information to the mode updating module 112 so that the mode 110 can be updated as specified in an automode table 114.

In one embodiment, an automode table 114 contains indication that the mode stack 110 should be updated based on temporal events, and a temporal event detection module 120 is provided. In various embodiments, the temporal event detection module 120 identifies relevant temporal events by querying an electronic calendar (which might be locally or remotely stored), by accessing a mode time schedule, or through other temporal event indicators. When a relevant temporal event occurs, the temporal event detection module 120 provides the relevant information to the mode updating module 112 so that the mode 110 can be updated as specified in an automode table 114.

In one embodiment, an automode table 114 contains indication that the mode stack 110 should be updated based on the state of one or more software applications that are executing on the device or on some other device, and an application detection module 122 is provided. The application detection module 122 detects the execution status of an application such as a media player, a phone function on the device, or other software application, and feeds that information to the mode updating module 112 so that the mode 110 can be automatically updated. For example, an automode table 114 may indicate that the device mode 110 should be “on phone” whenever the phone function is active; the application detection module 122 can signal the mode updating module 112 when the phone function is active so that the mode 110 can be updated to “on phone.” Similarly, the application detection module 122 can signal the mode updating module 112 when the phone function is no longer active so that the mode stack 110 can be updated so that “on phone” is no longer the current device mode (and perhaps reverting the current device mode to the next most-recently registered mode value on the mode stack).

In one embodiment, an automode table 114 contains indication that the mode stack 110 should be updated based on a communication event, and a communication detection module 124 is provided. The communication detection module may have access to a communication network 106 so that communications events can be detected. Examples of communication events include receiving a particular communication, entering into a communication link, or other events relating to communication. For example, a device user may indicate in an automode table 114 that the device should enter “home” mode whenever the device is connected to a wireless network based in the user's home. Alternately, the communication detection module 124 may have access to other communication interfaces, including those which are not part of a communication network, such as peer-to-peer communications.

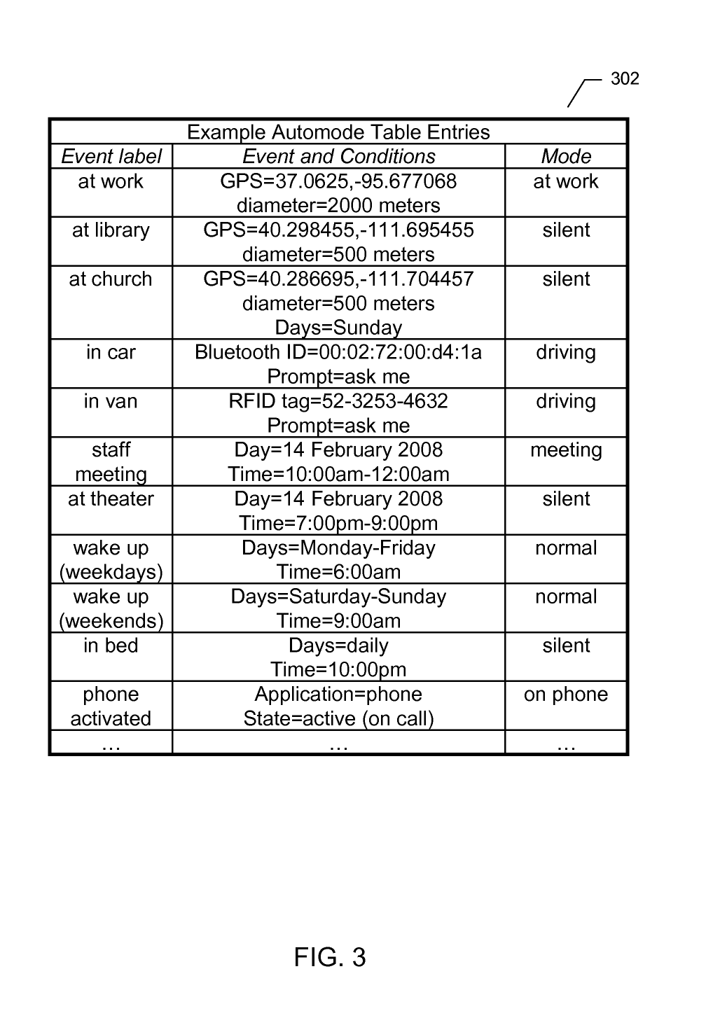

FIG. 2 shows examplary configurations of automode tables that tie events to automatic mode changes. The first automode table 202 is a simple example in which each table record indicates an event and the device mode pertaining to that event. The second automode table 204 has each record also optionally including conditions for each event, examples of which are shown in FIG. 3. These configuration examples 202 and 204 represent two possible embodiments of automode tables, and other embodiments might be used as desired. For example, the automode table might also record other information such as where entries come from, when entries are valid, and how entries might be interpreted.

FIG. 3 illustrates hypothetical automode table entries in one embodiment of an automode table 302. The “Event label” column is for reference. The “mode” column is the desired mode corresponding to the event being detected. Note that some entries imply entry and exit events, whereas other entries only have entry events. An entry event means that something is entering some condition. An exit event means that something is exiting some condition.

For example, the event labeled “at work” indicates that when the device enters within a range of 2000 meters of the GPS coordinates 37.0625, −95.677068 (longitude, latitude) the “at work” mode should be registered on the mode stack. (We might assume that those are the coordinates of the building where the hypothetical device user works, and that the footprint of the workplace is sufficiently encompassed by a 2000 meter circle. Those coordinates could be determined by various means, such as a GPS detector in the device or an online mapping service.) This entry also has an exit event, which means that when the device departs from that specified geographical area the corresponding mode should be unregistered on the mode stack.

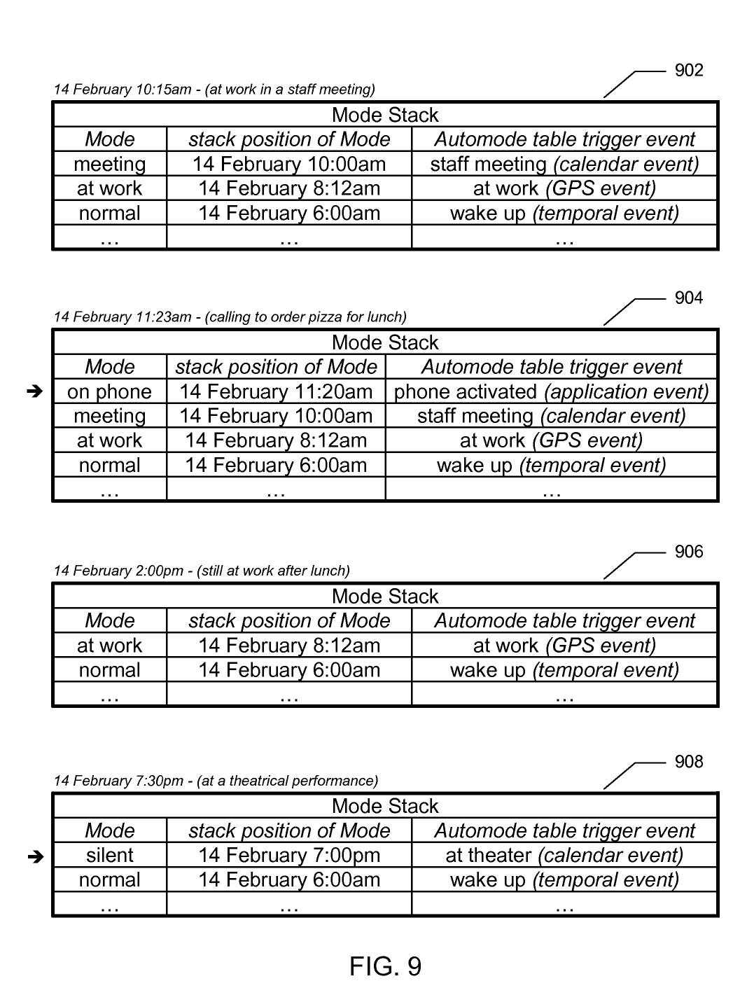

Registering a given mode on a mode stack can be accomplished in various ways. In one embodiment, the given mode can be added to the top of a mode stack, where the topmost entry is considered the current mode, as depicted in the example shown in FIG. 9. In another embodiment, the mode stack might have entries for a variety of modes, with a “recentness” field indicating the day and time each mode was most recently registered, wherein registering a given mode is accomplished by simply updating the recentness field corresponding to the given mode to the current date and time. In that case the current mode might be considered the mode stack entry with the most recent recentness value. (The recentness field could contain any ordinal value, such as serial integers which represent some ordering of recentness.)

In another embodiment, the mode stack might be only one element that is the current device mode, and registering a given mode would be simply changing the current device mode to the given mode. However, in preferred embodiments the mode stack has provision for containing multiple elements, with one or more elements representing the current device mode.

Unregistering a given mode can likewise be accomplished by various means in various embodiments. In one embodiment, the given mode is unregistered by removing it from the mode stack, as depicted in FIG. 9. In the “recentness” embodiment just described, a given mode might be unregistered by changing the recentness entry for the given mode to a null value or to some arbitrary value that indicates that it is no longer the most recent.

In the embodiment wherein the mode stack is only one element, unregistering a given mode can be accomplished by changing the mode stack from the given mode to some other mode, such as a default mode or some other mode that might seem applicable. A problem with this one-element mode-stack embodiment is that current modes might be nested, meaning that specific automode events may become active when other automode events are still active. FIG. 9 will show an example where the hypothetical device operator is at work and enters a meeting; when he enters the meeting he is still at work.

Other hypothetical examples of automode table entries are shown in FIG. 3. The “at library” entry indicates the geographical area of the library, which places the device in “silent” mode so that device alerts do not disturb other library patrons. The “at church” event is similar, with the coordinates of the church meeting place, but also with the condition that the automode event should only be considered on Sundays.

The hypothetical device user has a car which is equipped with a Bluetooth transceiver for various audio functions. The “in car” automode event entry indicates that when the device detects a Bluetooth signal from the given Bluetooth address (00:02:72:00:d4:1a) that the mode should be registered as “driving,” but only after first prompting the user (such as by asking for confirmation).

The hypothetical user's other vehicle is a van that does not have built-in Bluetooth. Therefore, the user places a Radio Frequency Identification (RFID) tag in the van, and indicates in the “in van” automode entry that when that RFID tag is detected the mode should change to “driving” (after confirmation).

The “staff meeting” and “at theater” automode events indicate time-periods to register and then unregister the specified modes in the mode stack (at event start and event end times respectively). Two different “wake up” automode entries are shown, one which triggers at 6:00 am on weekdays and the other which triggers at 9:00 am on weekends. Note that the wake up entries specify entry events but no exit events. For example, the weekday entry specifies to enter “normal” mode weekdays at 6:00 am, but does not specify when to exit normal mode. The “in bed” automode entry serves the purpose of registering “silent” mode on the mode stack at a time the user typically goes to bed (thus not disturbing sleep with audible alerts). In one embodiment automode entries that do not have exit events can assume exit events when a related entry event is triggered, such as the “in bed” event triggering the exit of the “wake up” event, which can help keep a mode stack from becoming cluttered with outdated information.

The final automode example in FIG. 3 is an application mode for when the “phone” application running on the device is active. When the “phone” application enters an active state the automode registers the “on phone” mode, and when the “phone” application comes out of the active state, the “on phone” mode can be unregistered from the mode stack.

The hypothetical examples shown in FIG. 3 are for illustration purposes, and by no means are intended to restrict or limit the types of automode table entries in other embodiments or actual implementations of this invention.

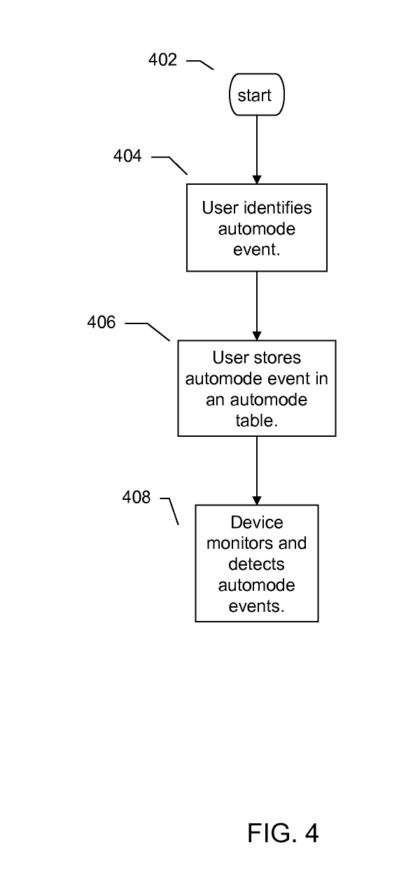

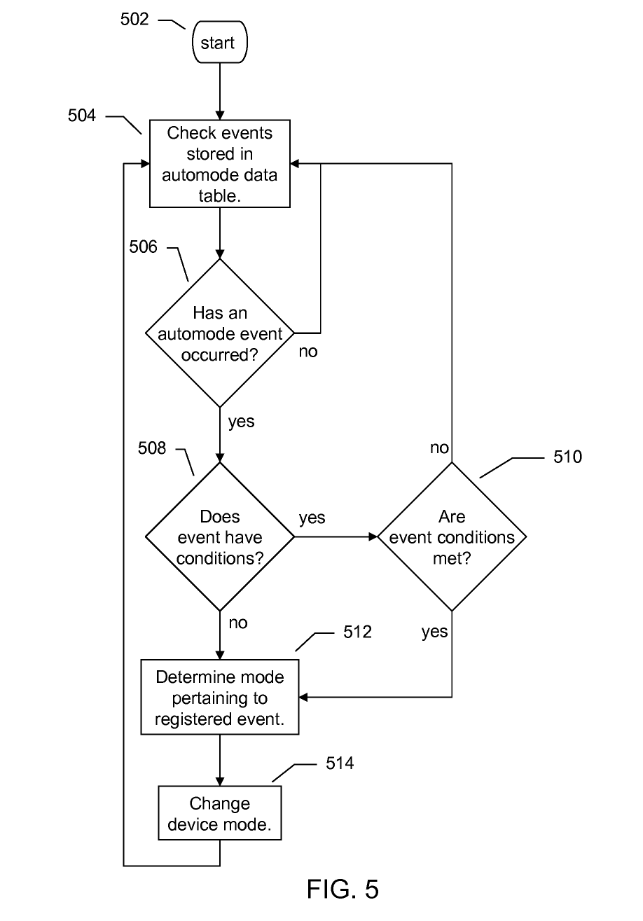

FIG. 4 is a flowchart of a method of an automode configuration module 116, for the purpose of populating an automode table. FIG. 4 also includes an element of a mode updating module 112. The procedure starts 402 when the user desires to configure automode functionality. The user identifies a given automode event 404, which may include determining desired parameters (geographical coordinates, time ranges, etc.). The automode event information is stored in an automode table 406. The device then monitors conditions that allow it to detect the automode events 408 and act accordingly, one embodiment of which is described in FIG. 5. Note that even though in preferred embodiments automode tables are user extensible, it is also likely that automode tables will come preconfigured for basic use.

FIG. 5 is a flowchart of a method for monitoring automode events, as might be included in a mode updating module 112. FIG. 5 has a start node 502, although it will be shown that in this embodiment the monitoring and processing of automode events is usually ongoing. The device checks events in an automode table 504 (or multiple automode tables) which repeats until an automode event occurs or is triggered 506. If the triggered event has conditions 508 then the conditions are checked 510. If the conditions are not met then the device simply continues monitoring events stored in an automode table 504. If there are not conditions 508 or if the conditions are met 510 then the relevant mode is determined from the automode table 512, and the mode stack is changed accordingly 514. Recall that changing the mode stack may include registering the relevant mode on the mode stack (e.g., for entry events) or unregistering the relevant mode from the mode stack (e.g., for exit events). After the mode stack is appropriately changed, the device continues to monitor automode events 504.

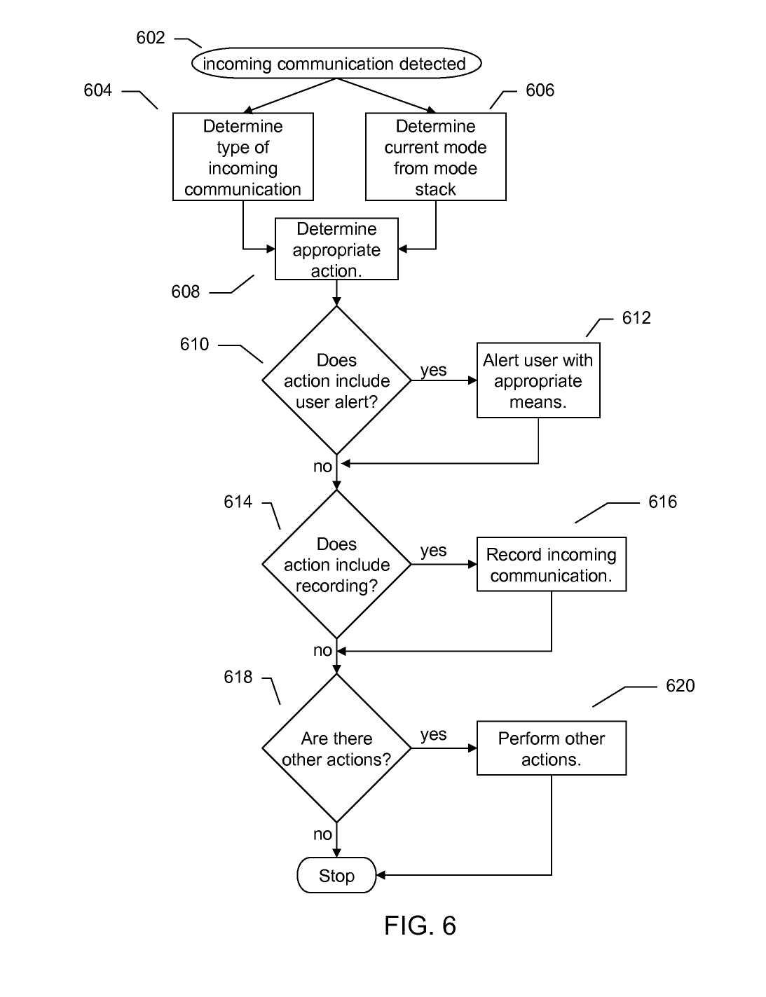

FIG. 6 is a flowchart of a method for processing incoming communications 108. The procedure begins 602 with an incoming communication being detected. Two items of information need to be determined: the type of incoming communication 604 and the current mode 606. FIG. 6 shows that these two items of information can be determined in any order, or even simultaneously. Shown also is that these two items of information are used to determine the appropriate action for processing the incoming communication 608.

The type of the incoming communication 604 can vary from one embodiment to another. In some embodiments, the type of communication may include voice communication, textual communication, or video communication. Further, the type of communication might be specified according to importance or priority, which might be based on the address (or phone number) of the originator of the incoming communication. The prior patents and application referenced in paragraph [0025] describe methods and systems for identifying caller types based on tokens or codes used by the originator of the incoming communication. In some embodiments the system may inquire of the originator as to his/her name and/or purpose for communicating, which can also be used to identify the type of incoming communication.

The current mode is determined from the mode stack 606. Some possible ways for doing this were described previously, including selecting the most recent mode registered on the mode stack. In some embodiments more than one mode might be simultaneously considered the current mode. In a common embodiment only one mode from the mode stack is considered the current mode.

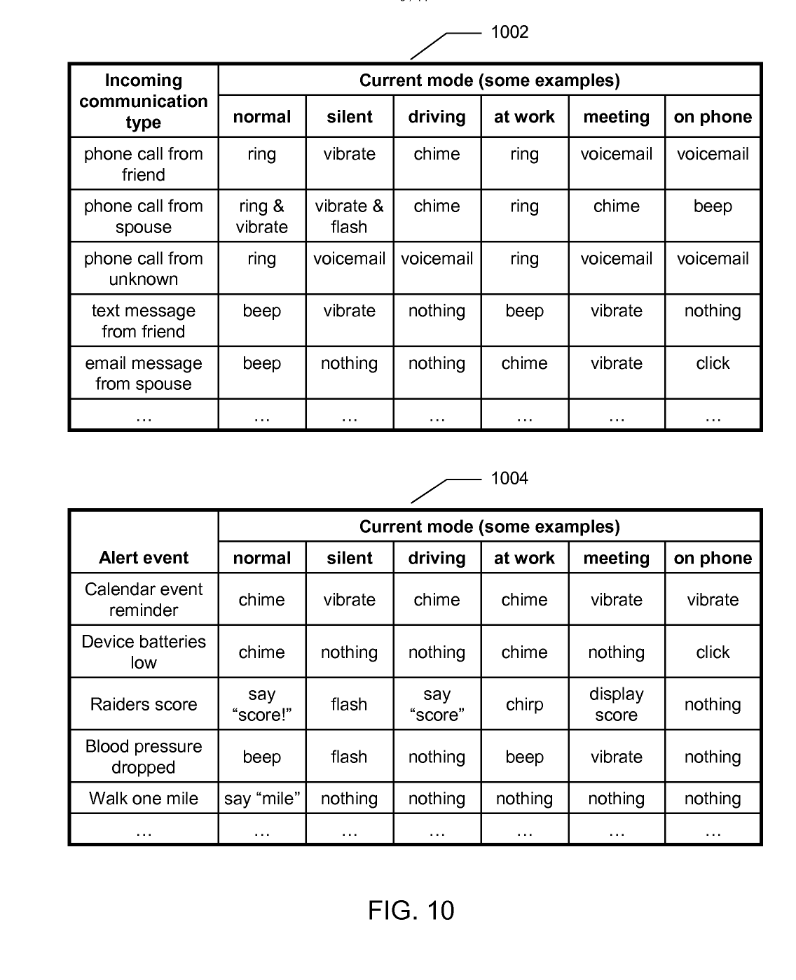

The type of incoming communication 604 and the current mode 606 can then be used to determine the appropriate action 608 for responding to the incoming communication. Examples of this type of mapping are depicted in FIG. 10. The actions may include audible, visual, or tactile alerts 610 which can be processed 612. The actions may include recording of the incoming communication 614 such as through voicemail, which can be processed 616. There may be other types of actions 618 to be performed 620. This invention focuses on automode functionality, and does not limit or restrict the types of actions.

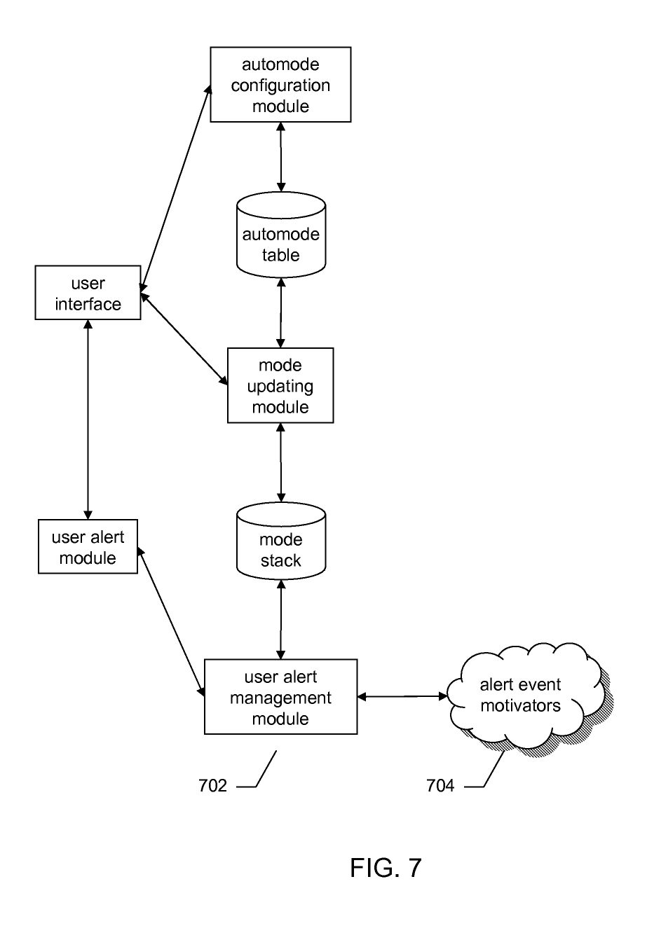

FIG. 7 is a schematic diagram of automode functionality within a general user-alert system. FIG. 7 is presented as a simplified version of FIG. 1 except for showing a user alert management module 702 instead of an incoming communication processing module 108. FIG. 7 demonstrates that the methodologies and modules described in this invention pertain to general alert events 704 that may or may not include incoming communication events. Examples of general alert events 704 may include scheduled time alarm events, sensor detection events, data source lookup events, and so forth. Examples of general alert events are given in FIG. 10.

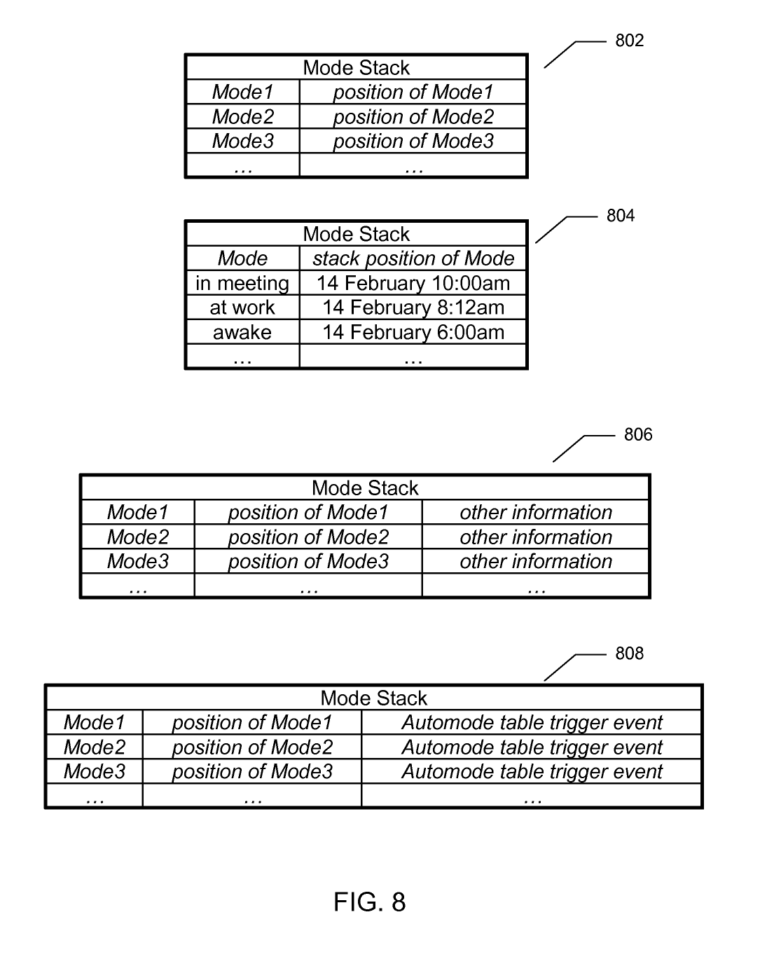

FIG. 8 illustrates exemplary configurations of mode stacks. Table 802 shows a simple mode stack that includes modes and an indication of the position of each mode in the mode stack. Note that alternatively the physical ordering of the modes might indicate their position, thus eliminating the need for a separate position indicator field. Table 804 shows a hypothetical example of the 802 type of mode stack embodiment. Note that the mode “in meeting” has the most recent registration time (stack position) and thus may be considered the “current mode.” If the “in meeting” mode were unregistered on the mode stack 804 it might be either removed from the mode stack or the position changed to a non-current value, leaving the “at work” mode as the current mode (unless the “at work” mode happened to be unregistered before the “in meeting” mode).

Table 806 illustrates that, in some embodiments, the mode stack might also contain other information. For example, table 808 shows an embodiment of a mode stack which contains information about the automode table entry which triggered each mode stack entry, which can be useful for identifying which mode-stack record to modify when an automode exit event occurs (by more easily identifying which mode stack entry to unregister in the case of an exit event).

FIG. 9 illustrates an exemplary mode stack as it changes throughout a hypothetical day. This illustrative mode stack is configured according to the table 808 embodiment, and relates to the automode event examples listed in FIG. 3. The hypothetical example is from a day in the life of a hypothetical device user. Table 902 shows a mode stack from 10:15 am of the given day, and shows three modes in the stack: At 6:00 am the mode became “normal” when the temporal “wake up” event occurred, at 8:12 am the device detected that it was within the geographical range of the work location, making the current mode “at work,” and at 10:00 am the calendar event “staff meeting” caused the mode stack entry “meeting” to be registered.

At 11:20 am the hypothetical device user uses the phone function of the device to call and order pizza. Table 904 shows the hypothetical mode stack containing the application event of the phone application being activated. When the phone function is deactivated (i.e. when the call is completed) the “on phone” entry is unregistered from the mode stack. The “meeting” mode entry also is unregistered at noon when the calendar event “staff meeting” experiences the end event (see FIG. 3). Table 906 shows the mode stack at 2:00 pm, when the user is still at work after lunch.

At 7:00 pm the calendar event “at theater” occurs based on the time-scheduled event, automatically registering “silent” mode on the mode stack. According to the schedule 302 that theater event ends at 9:00 pm, at which time the corresponding “silent” mode will be unregistered from the mode stack. Typical device actions for “silent” mode include suppressing most audible alerts, so as not to annoy other theater patrons.

Note that the example mode-stack tables in FIG. 9 contain ellipses (“ . . . ”) suggesting that the mode stack may include other registered device modes which are not shown. Some embodiments may include a default mode that is assumed when there are no other device mode values registered in the mode stack.

FIG. 10 shows exemplary device actions that are contingent upon the current device mode, and also contingent on the type of alert event. Table 1002 focuses on alert events pertaining to incoming communication. For example, if the incoming communication type is a phone call identified as coming from a friend (ascertained by caller ID, by the methods described in the prior patents and application referenced in paragraph [0025], or by some other means), then the device will produce an audible ring if the current mode is “normal” or “at work,” will vibrate if the current mode is “silent,” will chime if the current mode is “driving,” and will go directly to voicemail recording if the current mode is “meeting” or “on phone.” That way, the device user will not be bothered by friend calls while in a meeting. However, from the table we observe that calls identified as coming from the device user's spouse will produce a chime during meetings. (An alternative is to only chime important calls coming from the spouse during “meeting” mode, which type of call might be ascertained by methods and systems described in the prior patents and application referenced above.)

Table 1004 illustrates actions pertaining to alert events other than incoming communication events, and includes a few examples of how this invention can have embodiments in devices that are not necessarily communication devices. For example, if the device detects that the device batteries are at a low level, the device might provide an audible “chime” in “normal” or “at work” mode, but click or do nothing in the other listed modes. Alternatively, if the device user was a fan of the Oakland Raiders football team, the device might be configured to poll an external data source at some interval so as to identify when the Raiders score points in in-progress football games; various notifications of the team scoring can be give depending on the current mode, such as flashing a device light when the current mode is “silent.” This allows the device user to receive the notification while in the library or other “silent” automode locations.

Table 1004 includes two examples relating to physical fitness. If the device is able to detect blood pressure of a device operator, then an automode table might be configured to trigger an event which is the blood pressure dropping below a specified level. Table 1004 shows how that event might lead to different alerts depending upon the current mode of the device. Alternatively, if the device has an accelerometer or other movement detection capability, an automode event might be specified as a device operator walking one mile, leading to different alert feedback depending on the mode. Table 1004 shows an audible “mile” alert in “normal” mode, although an automatic or manually specified “exercise” mode might alternatively allow audible reports of distance traversed.

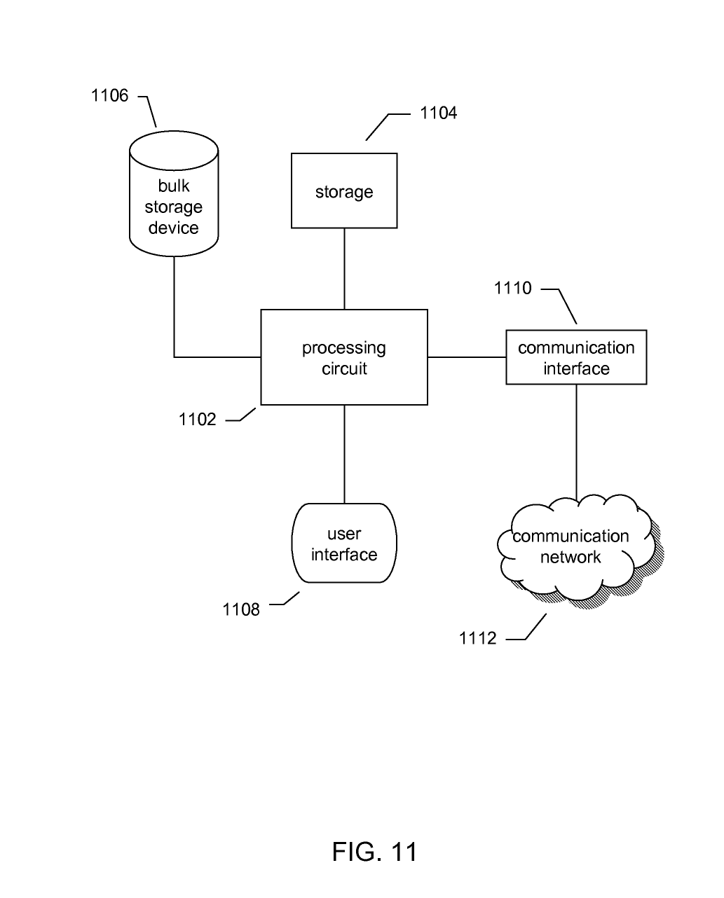

FIG. 11 depicts a simplified high-level block diagram of a communication device in one embodiment of this invention. The device has a processing circuit 1102 which is connected to a storage area 1104, although in some embodiments the processing circuit 1102 and the storage area 1104 are part of the same physical circuit component. The storage area 1104 may be some combination of volatile or nonvolatile memory. Functions of the storage area 1104 may include storing a mode stack 110 and/or storing an automode table 114.

An optional bulk storage device 1106 is also provided for storing data tables. The processing circuit 1102 is also coupled to a user interface 1108 which comprises a display and some means for user input to the system. In embodiments in which the device is a communication device, a communication interface 1110 is provided for connecting to an external communication network 1112 of some type. The communication network 1112 may be some combination of wired and/or wireless networks. In embodiments where the device is not a communication device, the communication interface 1110 may be omitted.

The above description provides numerous specific details for a thorough understanding of the embodiments described herein. However, those of skill in the art will recognize that one or more of the specific details may be omitted, or other methods, components, or materials may be used. In some cases, operations are not shown or described in detail.

Furthermore, the described features, operations, or characteristics may be combined in any suitable manner in one or more embodiments. It will also be readily understood that the order of the steps or actions of the methods described in connection with the embodiments disclosed may be changed as would be apparent to those skilled in the art. Thus, any order in the drawings or Detailed Description is for illustrative purposes only and is not meant to imply a required order, unless specified to require an order.

Embodiments may include various steps, which may be embodied in machine-executable instructions to be executed by a general-purpose or special-purpose computer (or other electronic device). Alternatively, the steps may be performed by hardware components that include specific logic for performing the steps or by a combination of hardware, software, and/or firmware.

Embodiments may also be provided as a computer program product including a computer-readable medium having stored thereon instructions that may be used to program a computer (or other electronic device) to perform processes described herein. The computer-readable medium may include, but is not limited to: hard drives, floppy diskettes, optical disks, CD-ROMs, DVD-ROMs, ROMs, RAMs, EPROMs, EEPROMs, magnetic or optical cards, solid-state memory devices, or other types of media/machine-readable medium suitable for storing electronic instructions.

As used herein, a software module or component may include any type of computer instruction or computer executable code located within a memory device and/or transmitted as electronic signals over a system bus or wired or wireless network. A software module may, for instance, comprise one or more physical or logical blocks of computer instructions, which may be organized as a routine, program, object, component, data structure, etc. that performs one or more tasks or implements particular abstract data types.

In certain embodiments, a particular software module may comprise disparate instructions stored in different locations of a memory device, which together implement the described functionality of the module. Indeed, a module may comprise a single instruction or many instructions, and may be distributed over several different code segments, among different programs, and across several memory devices. Some embodiments may be practiced in a distributed computing environment where tasks are performed by a remote processing device linked through a communications network. In a distributed computing environment, software modules may be located in local and/or remote memory storage devices. In addition, data being tied or rendered together in a database record may be resident in the same memory device, or across several memory devices, and may be linked together in fields of a record in a database across a network.

It will be understood by those having skill in the art that many changes may be made to the details of the above-described embodiments without departing from the underlying principles of the invention. The scope of the present invention should, therefore, be determined only by the following claims.

What is claimed is:

1. A method for managing the mode and function of a communication device wherein the communication device has a mode stack that contains an ordered list of current device modes with provision for multiple current device modes and wherein one or more current device mode values in the mode stack may be designated as the most recently registered current device mode;
a device operator storing in a data table:
a) an indication of an event that can be automatically detected by the communication device, and
b) an associated device mode value;
detecting an event previously stored in the data table;
determining the relevant device mode value as the device mode value associated in the data table with the detected event; and
changing the mode of the communication device by altering the registration of the relevant device mode value within the mode stack.

2. The method of claim 1 wherein the elements in the mode stack are represented as being chronologically-ordered according to the time in which each element was most recently registered in the mode stack.

3. The method of claim 1 wherein the detected event comprises one or more of
the communication device entering a specified geographical area,
the communication device connecting to an external device,
the communication device entering into communication with an external device,
the communication device receiving a communication from an external entity,
the communication device beginning to process a communication stream,
a software program entering a specific functional state on the communication device,
the current day and time reaching the day and time of a scheduled mode change,
the current day and time entering the day and time range of an event recorded in an electronic calendar, and,
the communication device detecting a proximal radio frequency identification device.

4. The method of claim 3 wherein the communication stream is from the set of a telephone call, a video call, an audio transmission, a video transmission, a textual transmission, and a data file transmission.

5. The method of claim 1 wherein altering the registration of the relevant device mode value within the mode stack comprises adding the relevant device mode value to the mode stack, thereby making the relevant device mode value the most recently registered current device mode value in the mode stack.

6. The method of claim 1 wherein altering the registration of the relevant device mode value within the mode stack comprises updating a flag pertaining to the relevant device mode value within the mode stack, thereby making the relevant device mode value the most recently registered current device mode value in the mode stack.

7. The method of claim 6 wherein the flag is a date and time stamp.

8. The method of claim 1 wherein the detected event comprises one or more of
the communication device exiting a specified geographical area,
the communication device ceasing to be connected to an external device,
the communication device ceasing communication with an external device,
the communication device ceasing to process a communication stream,
a software program exiting a specific functional state on the communication device,
the current day and time leaving the day and time range of an event recorded in an electronic calendar, and,
the communication device ceasing to detect a proximal radio frequency identification device.

9. The method of claim 8 wherein the communication stream is from the set of a telephone call, a video call, an audio transmission, a video transmission, a textual transmission, and a data file transmission.

10. The method of claim 1 wherein altering the registration of the relevant device mode value within the mode stack comprises removing the associated device mode value from the mode stack, thereby assuring that the relevant device mode value is no longer registered as a current device mode value in the mode stack.

11. The method of claim 1 wherein altering the registration of the relevant device mode value within the mode stack comprises updating a flag pertaining to the relevant device mode value in the mode stack, thereby assuring that the relevant device mode value is no longer registered as a current device mode value in the mode stack.

12. The method of claim 11 wherein updating the flag comprises changing the flag to a value which indicates that the relevant device mode value is no longer a current device mode.

13. The method of claim 1 wherein the communication device prompts a device operator prior to altering the registration of the relevant device mode value within the mode stack.

14. The method of claim 1 further comprising:
detecting an alert event, and,
processing the alert event according to the most recently registered current device mode value in the mode stack.

15. The method of claim 14 wherein the alert event is an incoming communication.

16. The method of claim 15 wherein processing the alert event comprises one or more of providing an audible alert, providing a visual alert, providing a tactile alert, requesting additional information from the sender of the incoming communication, directing the incoming communication to a recording system, and rejecting the incoming communication.

17. The method of claim 14 wherein the alert event is a reminder of an item recorded in an electronic calendar.

18. The method of claim 17 wherein processing the alert event comprises one or more of providing an audible alert, providing a visual alert, providing a tactile alert.

19. A system for managing the mode and function of a communication device including:
a mode stack that functions as an ordered list of device mode values with one device mode value in the mode stack being the most recently registered device mode value in the mode stack;
a configuration module that allows a device operator to store in a data table:
a) an indication of an event that can be automatically detected by the communication device, and
b) an associated device mode value;
a detection module for detecting an event previously stored in the data table; and
a mode-stack updating module for looking up the relevant device mode value as the device mode value associated in the data table with the detected event and changing the mode of the communication device by altering the registration of the relevant device mode value within the mode stack.

20. A communication device comprising:
a processor;
a first storage area coupled to the processor for storing a mode stack that contains a plurality of device mode values and provision for storing and indication of how recent specific device mode values were registered in the mode stack;
a storage area coupled to the processor for storing a plurality of indications of events that can be automatically detected by the device with storage of corresponding device mode values.
a display module for generating a user interface with provision for a user to store
a) an indication of an event that can be automatically detected by the communication device, and
b) an associated device mode value;
a detection subsystem for detecting a previously stored event;
a mode determination subsystem for determining the relevant device mode value as the device mode value associated in the second memory with the detected event; and
a mode changing subsystem for changing the mode of the communication device by altering the registration of the relevant device mode value within the mode stack.
